(19) United States
(12) Patent Application Publication
(10) Pub. No.: US 2007/0008846 A1
(43) Pub. Date: Jan. 11, 2007

(54) METHOD FOR BACKING UP DATA ON AN OPTICAL STORAGE MEDIUM

(76) Inventors: Jan-Gee Chen, Taipei City (TW); Chia-Tse Liang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/163,316

(22) Filed: Oct. 14, 2005

(30) Foreign Application Priority Data
Jul. 8, 2005 (TW) 094123185

(51) Int. Cl. G11B 20/10

(52) U.S. Cl. 369/47.12

(57) ABSTRACT

An optical storage medium includes N isometric sectors. Back up data includes storing data to be backed up on N-1 isometric sectors of the optical storage medium, performing an XOR operation for the data to be backed up so as to generate a check datum, and storing the check datum on a remaining isometric sector.

### BACKGROUND OF THE INVENTION

1. Field of the Invention

The present invention relates to a method for backing up data on an optical storage medium, and more particularly, to a method for backing up data on an optical storage medium and restoring stored data correctly when the optical storage medium is damaged.

2. Description of the Prior Art

Optical disks, because of their low price, small volume, light weight, and large storage capacity, have become one of the most common data storage media used in modern society. More specifically, the development of rewritable optical disks has made the optical disk the most important portable personal data storage media that can store a user's data depending on the user's demand. Therefore, how to access disk data with higher efficiency and reliability has become the main point of modern information development.

An optical disk drive accesses data in a corresponding optical disk. Please refer to FIG. 1. FIG. 1 is a block diagram of a conventional optical disk drive 10 accessing an optical disk 22. The optical disk drive 10 comprises a pedestal 14, a motor 12 for driving the pedestal 14 to rotate, an optical pickup head 16 for accessing the data in the optical disk 22, a controller 18 for controlling the operation of the optical disk drive 10, and a memory 20 (such as volatile random access memory) for storing the data during the operation duration of controller 18. The optical disk 22 has a track 24 for recording the data. The controller 18, depending on the command from a host 26, can access the data on the track 24 with the optical pickup head 16 skipping the track 24 of the optical disk 22 set on the pedestal 14 driven by the motor 12. The host 26 could be a computer system of a PC (Personal Computer).

There are several kinds of specifications of the optical disk 22, such as CD-R, CD-RW, DVD-R/RW, DVD+R/RW, DVD-RAM, and so on. The development of DVDs (digital versatile disks) has made the DVD the most important portable personal data storage media due to its high storage capacity. The storage capacity of the DVD is from 4.7 GB to 17 GB so that users can store a large amount of Video/Audio data with high quality or back up important personal data in the DVD. However the frailty of the digital versatile disk is the same as that of the normal optical disk. More specifically, the storage capacity of the DVD is above seven times the storage capacity of the compact disk, so a little scratch might cause large data loss. As shown in FIG. 1, when the track 24 of the optical disk 22 is scratched, the optical pickup head 16 can not access the data on the track 24 correctly.

However, often not all storage space of the optical disk 22 is utilized for storing data of the optical disk 22. Even so, a scratch on the optical disk 22 can still cause data loss. Even the user uses same optical disk for data backup, the scratch can still cause problems. There is a need to build a recover mechanism when storing data in the optical disk simultaneously with the character of high storage capacity.

### SUMMARY OF THE INVENTION

It is therefore a primary objective of the claimed invention to provide a method for backing up data on an optical storage medium and restoring stored data correctly when the optical storage medium is damaged for solving the above-mentioned problem.

According to claimed invention, a method for backing up data on an optical storage medium is disclosed. The optical storage medium includes N isometric sectors. The method includes storing the data desired to be backed up on N-1 isometric sectors of the optical storage medium respectively, performing an XOR operation for the data desired to be backed up so as to generate a check datum, and storing the check datum on an isometric sector not used for storing the data.

According to claimed invention, an optical storage medium capable of restoring stored data correctly includes a plurality of data sectors for storing data, and a check sector for storing a check datum generated by an XOR operation for the data stored on the plurality of data sectors.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a conventional optical disk drive accessing an optical disk.

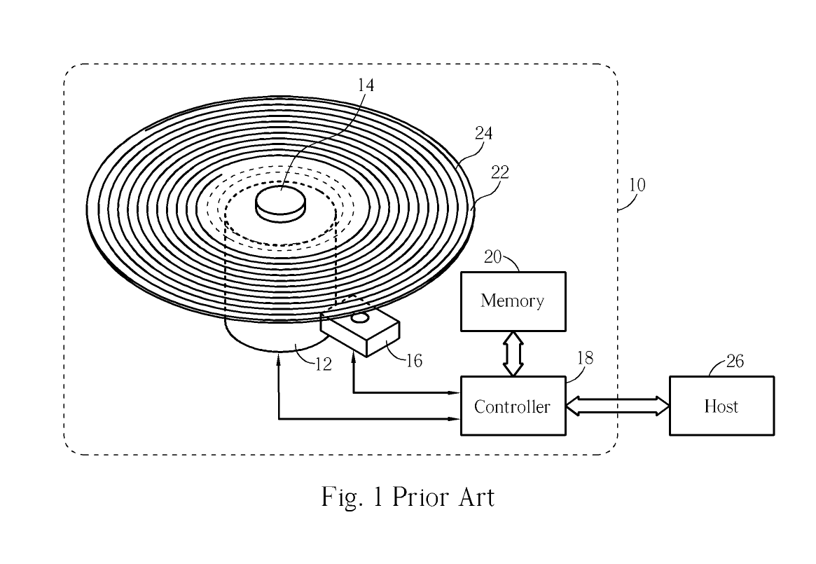

FIG. 2 is a block diagram of an optical disk drive accessing an optical storage medium according to the present invention.

FIG. 3 is a distribution diagram of sectors of the optical storage medium in FIG. 2.

FIG. 4 is a flowchart of storing data in the optical storage medium in FIG. 2.

FIG. 5 is a truth table of an XOR operation for three bits.

### DETAILED DESCRIPTION

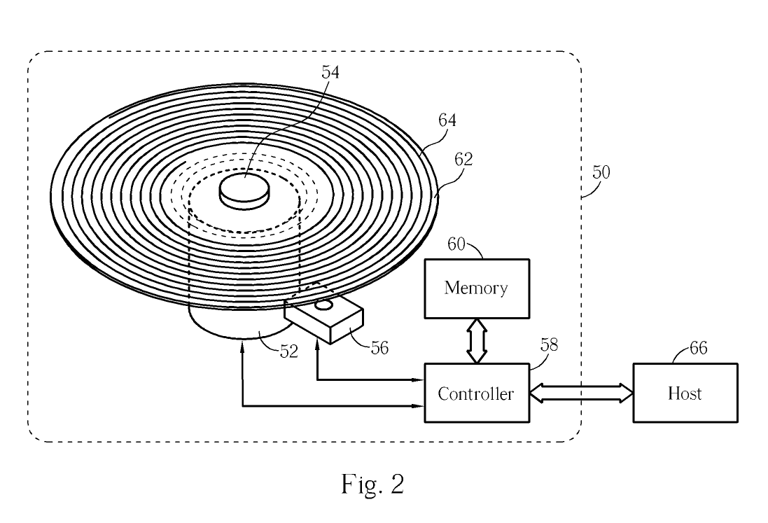

Please refer to FIG. 2. FIG. 2 is a block diagram of an optical disk drive 50 accessing an optical storage medium 62 according to the present invention. The optical disk drive 50 includes a pedestal 54, a motor 52 for driving the pedestal 54 to rotate, an optical pickup head 56 for accessing the data in the optical storage medium 62, a controller 58 for controlling the operation of the optical disk drive 50, and a memory 60 (such as volatile random access memory) for temporarily storing the data during the operation of controller 58. The optical storage medium 62 has a track 64 for recording the data. The controller 58, depending on the command from a host 66, can access the data on the track 64 with the optical pickup head 56 skipping the track 64 of the optical storage medium 62 set on the pedestal 54 driven by the motor 52. The host 66 could be a computer system of a PC (Personal Computer). The optical storage medium 62 could be a CD-R, CD-RW, DVD-R/RW, DVD+R/RW, DVD-RAM, and so on.

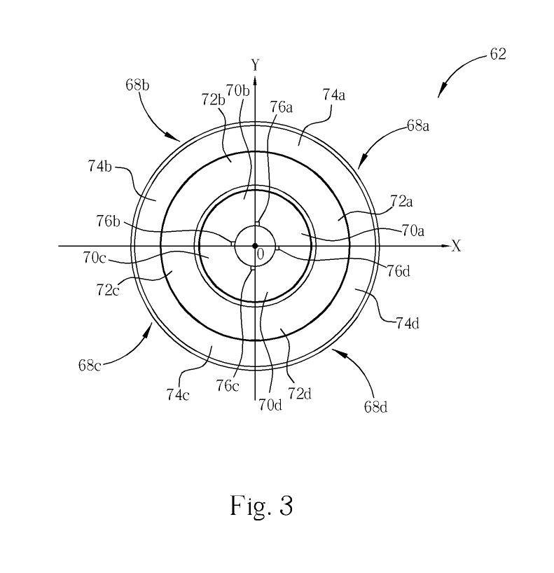

Please refer to FIG. 3. FIG. 3 is a distribution diagram of sectors of the optical storage medium 62 according to the present invention. The optical storage medium 62 is divided into a plurality of data sectors for storing data. In this embodiment, the X, Y coordinate axes divide the optical storage medium 62 into four identical sections, 68a, 68b, 68c, 68d. The section 68a includes a first isometric sector 70a, a second isometric sector 72a, and a third isometric sector 74a. The section 68b includes a first isometric sector 70b, a second isometric sector 72b, and a third isometric sector 74b. The section 68c includes a first isometric sector 70c, a second isometric sector 72c, and a third isometric sector 74c. The section 68d includes a first isometric sector 70d, a second isometric sector 72d, and a third isometric sector 74d. The first isometric sector 70a, the first isometric sector 70b, the first isometric sector 70c, and the first isometric sector 70d are isometric and in central symmetry according to the central point O. The second isometric sector 72a, the second isometric sector 72b, the second isometric sector 72c, and the second isometric sector 72d are isometric and in central symmetry according to the central point O. The third isometric sector 74a, the third isometric sector 74b, the third isometric sector 74c, and the third isometric sector 74d are isometric and in central symmetry according to the central point O. Sections 68a, 68b, 68c, and 68d are not limited to include only three isometric sectors. Users can decide the number of the isometric sectors of the section, and the number of the isometric sectors of the section corresponds to the status of stored data. In addition, the first isometric sector 70a includes a datum cell 76a, the first isometric sector 70b includes a datum cell 76b, the first isometric sector 70c includes a datum cell 76c, and the first isometric sector 70d includes a datum cell 76d.

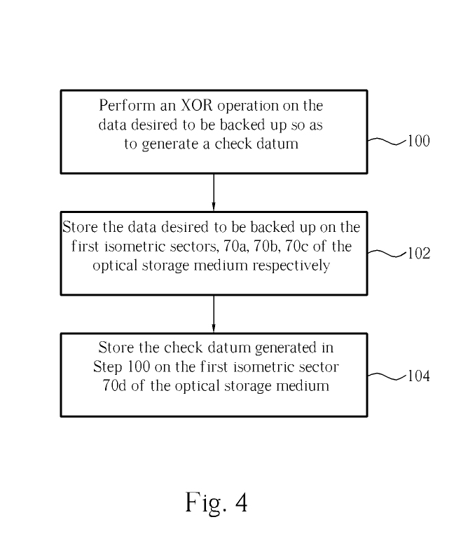

Please refer to FIG. 4. FIG. 4 is a flowchart of storing data in the optical storage medium 62 according to the present invention. The method includes the following steps:

Step 100: Perform an XOR operation on the data desired to be backed up so as to generate a check datum.

Step 102: Store the data desired to be backed up on the first isometric sectors, 70a, 70b, 70c of the optical storage medium 62 respectively.

Step 104: Store the check datum generated in Step 100 on the first isometric sector 70d of the optical storage medium 62.

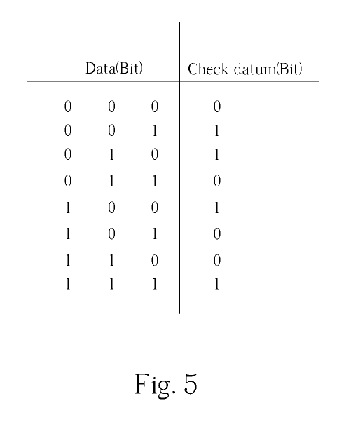

The detailed description of the method is as follows. Please refer to FIG. 5. FIG. 5 is a truth table of an XOR operation for three bits. The host 66 can perform an XOR operation for the data being stored to the optical storage medium 62 so as to generate a corresponding parity check datum according the truth table shown in FIG. 5. A check datum in a bit is generated according to three data being stored to the optical storage medium 62 in a bit. Then the host 66 can control the controller 58 to store the data on the first isometric sector 70a, the first isometric sector 70b and the first isometric sector 70c, and to store the check data on the first isometric sector 70d of the optical storage medium 62 with the optical pickup head 56. Similarly, the following data being stored in the optical storage medium 62 can be stored on the second isometric sector 72a, the second isometric sector 72b, the second isometric sector 72c, and the check data generated according to the XOR operation of the corresponding data being stored in the optical storage medium 62 can be stored on the second isometric sector 72d. And the following data being stored in the optical storage medium 62 can be stored on the third isometric sector 74a, the third isometric sector 74b, the third isometric sector 74c, and the check data generated according to the XOR operation of the corresponding data being stored in the optical storage medium 62 can be stored on the third isometric sector 74d.

In addition, the data and the check data is not limited to being stored on certain isometric sectors. For instance, the check data generated first can be stored on any isometric sector of the first isometric sectors 70a, 70b, 70c, 70d. The rest of the isometric sectors are utilized for storing the correspondingly backed up data. The following data and check data are not limited to being stored on the corresponding isometric sectors. For instance, when the check data generated first is stored on the first isometric sector 70d, the following check data are not limited to being stored on the second isometric sector 72d. So the objective of storing data desired to be backed up on three of the four isometric sectors and storing check data on the rest isometric sector can be achieved well.

When the isometric sector is damaged so that the data stored on the isometric sector can not be read, the data can be recovered by reading the corresponding data and check data stored on the corresponding isometric sectors. For instance, as shown in FIG. 3, the data desired to be backed up are respectively stored on the data cell, 76a, 76b, 76c, and the check datum generated by the XOR operation of the data stored on the data cell, 76a, 76b, 76c is stored on the data cell 76d. When the data cell 76a is damaged so that the data stored on the data cell 76a can not be read, the host 66 can access the data stored on the data cell 76b, 76c, 76d and recover the datum stored on the data cell 76a according to the truth table in FIG. 5. For example, if the bit value stored on the data cell 76b is 0, the bit value stored on the data cell 76c is 1, and the bit value stored on the data cell 76d is 1, the bit value stored on the data cell 76a can be inferred to be 0 according to the truth table in FIG. 5.

In the above-mentioned embodiment, the optical storage medium 62 is divided into four sections, 68a, 68b, 68c, 68d, so a quarter of the capacity of the optical storage medium 62 is utilized for data recover mechanism. The proportion of the capacity of the optical storage medium 62 utilized for data recover mechanism can be decided by users. For instance, the optical storage medium 62 can be also divided into three sections, so one third of the capacity of the optical storage medium is utilized for data recover mechanism and two thirds of the capacity of the optical storage medium is utilized for storing data.

In contrast to a conventional method for backing up data on an optical storage medium, the method according to the present invention builds up a recover mechanism when storing data in the optical disk simultaneously with the character of high storage capacity by itself. The present invention can recover the data stored on the optical storage medium when the optical storage medium is scratched so that the data stored on the optical storage medium can not be read.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for backing up data on an optical storage medium, the optical storage medium comprising N isometric sectors, the method comprising:
(a) storing the data desired to be backed up on N-1 isometric sectors of the optical storage medium respectively;
(b) performing an XOR operation for the data desired to be backed up so as to generate a check datum; and
(c) storing the check datum on an isometric sector not used for storing the data in step (a).

2. The method of claim 1 further comprising:
(d) reading the data stored on the N-1 isometric sectors of the optical storage medium and the check datum; and
(e) restoring the data according to the data stored on the N-1 isometric sectors of the optical storage medium and the check datum read in step (d).

3. The method of claim 1 wherein the optical storage medium is a digital versatile disk (DVD).

4. The method of claim 1 wherein the optical storage medium is a compact disk (CD).

5. An optical storage medium capable of restoring stored data correctly comprising:
a plurality of data sectors for respectively storing data desired to be backed up; and
a check sector for storing a check datum generated by an XOR operation for the data stored on the plurality of data sectors.

6. The optical storage medium of claim 5 wherein the data sector and the check sector are isometric.

7. The optical storage medium of claim 5 being a digital versatile disk (DVD).

8. The optical storage medium of claim 5 being a compact disk (CD).
